(19) United States
(12) Patent Application Publication
(10) Pub. No.: US 2011/0175846 A1
(43) Pub. Date: Jul. 21, 2011

(54) TOUCH DISPLAY PANEL

(75) Inventors: Po-Hsien Wang, Taichung City (TW); Chih-Chang Lai, Taichung County (TW)

(73) Assignee: WINTEK CORPORATION, Taichung (TW)

(21) Appl. No.: 12/951,077

(22) Filed: Nov. 22, 2010

(30) Foreign Application Priority Data
Jan. 21, 2010 (TW) 99101671

(51) Int. Cl. G06F 3/044

(52) U.S. Cl. 345/174

(57) ABSTRACT

A touch display panel including a cover plate, a plurality of touch sensing electrodes and a display panel is provided. The touch sensing electrodes are disposed on a surface of the cover plate. The display panel is adhered to the cover plate via an adhesion layer, and includes a substrate, a plurality of scan lines, an opposite substrate parallel to the substrate and a display medium layer disposed between the substrate and the opposite substrate. The touch sensing electrodes are disposed between the cover plate and the substrate. The scan lines are disposed on a surface of the substrate, wherein the scan lines and the touch sensing electrodes are disposed at different sides of the substrate and a sensing capacitance is formed between the touch sensing electrodes and the scan lines.

### CROSS-REFERENCE TO RELATED APPLICATION

This application claims the priority benefit of Taiwan application serial no. 99101671, filed on Jan. 21, 2010. The entirety of the above-mentioned patent application is hereby incorporated by reference herein and made a part of this specification.

### BACKGROUND

1. Field of the Invention

The invention relates to a touch display panel. Particularly, the invention relates to a touch display panel of a simple structure and a simple fabrication process.

2. Description of Related Art

Generally, touch panels are grouped into resistive touch panels, capacitive touch panels, optical touch panels, and acoustic wave touch panels, etc. A current trend of product is to integrate the touch panel into a display panel, so as to form a touch display panel. Taking the commonly used resistive touch panel and the capacitive touch panel as examples, according to a design of the touch panel, two layers of electrode layers are used for scanning and sensing operations. That is, to integrate the touch panel to the display panel, at least two layers of the electrode layers have to be additionally fabricated on the display panel, which may complicate a fabrication process thereof.

Moreover, the display panel is generally formed by two substrates. The two layers of the electrode layers used for touch sensing have to be fabricated on one of the two substrates closed to the user for providing a good touch sensing effect. However, such design may increase thickness of the display panel, and a circuit board has to be additionally used to connect the electrode layers to a driving circuit. Therefore, the fabrication process of the touch display panel is further complicated.

### SUMMARY OF THE INVENTION

The invention is directed to a touch display panel, which has a simple structure and a simple fabrication process.

The invention provides a touch display panel including a cover plate, a plurality of touch sensing electrodes and a display panel. The touch sensing electrodes are disposed on a surface of the cover plate. The display panel is adhered to the cover plate via an adhesion layer, and includes a substrate, a plurality of scan lines, an opposite substrate parallel to the substrate and a display medium layer. The touch sensing electrodes are disposed between the cover plate and the substrate. The scan lines are disposed on a surface of the substrate, wherein the scan lines and the touch sensing electrodes are disposed at different sides of the substrate and a sensing capacitance is formed between the touch sensing electrodes and the scan lines.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a touch display panel according to a first embodiment of the invention.

FIG. 1B is a top view of touch sensing electrodes and a pixel array of FIG. 1A.

FIG. 2A is a cross-sectional view of a touch display panel according to a second embodiment of the invention.

FIG. 2B is a top view of touch sensing electrodes and scan lines of FIG. 2A.

FIG. 2C is a top view of an opposite substrate of FIG. 2A.

FIG. 3 is a top view of another type of scan lines of a touch display panel of a second embodiment of the invention.

FIG. 4 is a top view of still another type of scan lines of a touch display panel of a second embodiment of the invention.

FIG. 5 is a top view of touch sensing electrodes of a touch display panel according to an embodiment of the invention.

FIG. 6 is a top view of touch sensing electrodes of a touch display panel according to an embodiment of the invention.

### DETAILED DESCRIPTION OF DISCLOSED EMBODIMENTS

### First Embodiment

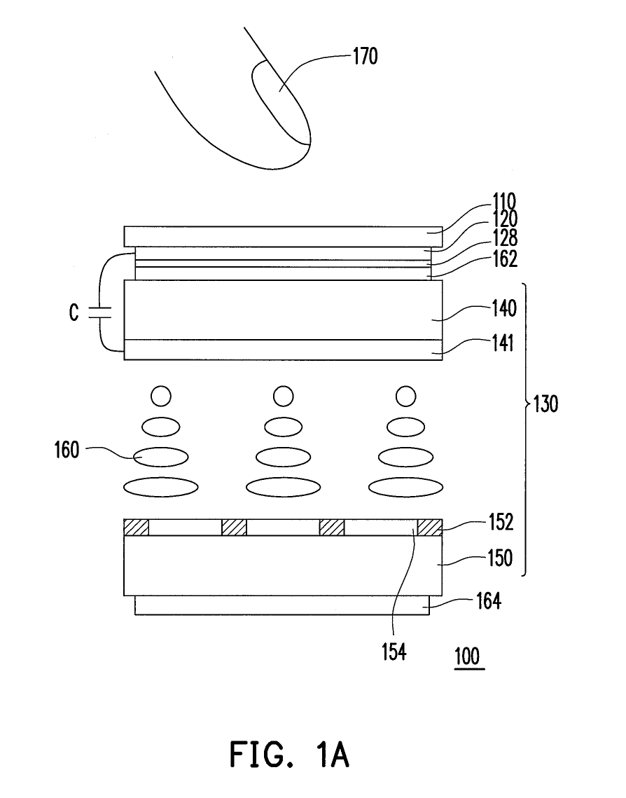

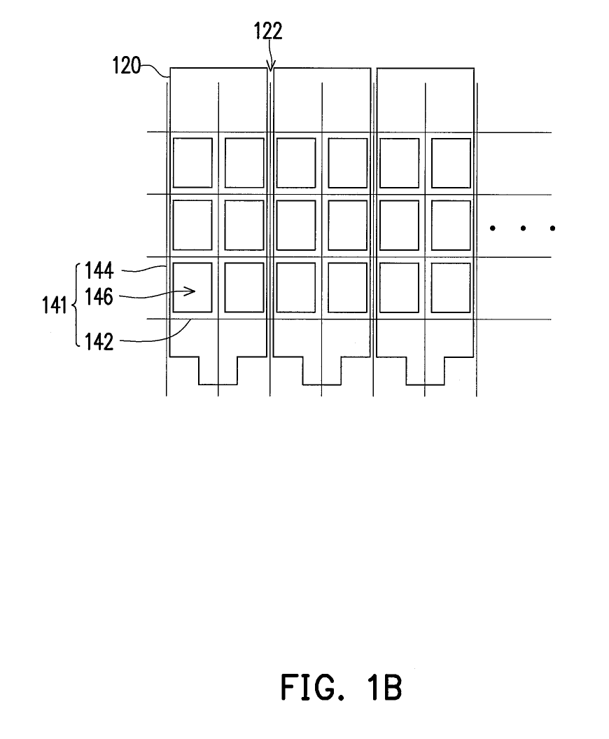

Referring to FIG. 1A and FIG. 1B, a touch display panel 100 includes a cover plate 110, a plurality of touch sensing electrodes 120, an adhesion layer 128 and a display panel 130.

The display panel 130 includes a substrate 140, an opposite substrate 150 and a display medium layer 160, wherein the opposite substrate 150 is parallel to the substrate 140. The display medium layer 160 is disposed between the substrate 140 and the opposite substrate 150. The substrate 140 is a pixel array substrate, and a pixel array 141 is disposed thereon. The pixel array 141 includes a plurality of scan lines 142, a plurality of data lines 144 and a plurality of pixel structures 146. Each of the pixel structures 146 is electrically connected to one of the scan lines 142 and one of the data lines 144, and the scan lines 142 are not parallel to the data lines 144. The data lines 144 are disposed at a side of the substrate 140 different to a side where the touch sensing electrodes 120 are located, i.e. the data lines 144 and the touch sensing electrodes 120 are disposed at different sides of the substrate 140.

In the present embodiment, during the operation of the pixel array 141, the scan lines 142 gradually scan so that signals in the data lines 144 are transmitted to the corresponding pixel structures 146. Now, scan signals of the scan lines 142 can serve as scan signals for touch sensing, and gate lines in the display panel 130 directly serve as the scan lines 142, so that it is unnecessary to configure additional touch scan devices to the touch display panel 100 of the present embodiment for the touch function. A sensing capacitance C is formed between the touch sensing electrodes 120 and the scan lines 142, and when a conductive object 170 approaches the cover plate 110, a position of the conductive object 170 can be calculated according to a variation of the sensing capacitance C, wherein the conductive object 170 can be a user's finger, a metal piece, or a conductive stylus, etc.

Referring to FIG. 1A, in the present embodiment, to achieve a full color display, the touch display panel 100 further includes light-shielding patterns 152 and color filter patterns 154. The light-shielding patterns 152 and the color filter patterns 154 are disposed on the opposite substrate 150, and the opposite substrate 150 is a transparent substrate. Certainly, in other embodiments, the light-shielding patterns 152 and the color filter patterns 154 can also be disposed on the substrate 140, or the touch display panel 100 does not include the light-shielding patterns 152 and the color filter patterns 154. A material of the display medium layer 160 can be a liquid crystal material, a plasma material, an organic light emitting display (OLED) material, or an electrophoresis material. If the material of the display medium layer 160 is the liquid crystal material, an upper polarizer 162 and a lower polarizer 164 are adhered to the display panel 130. The upper polarizer 162 is disposed on an outer surface of the substrate 140, and the lower polarizer 164 is disposed on an outer surface of the opposite substrate 150.

Referring to FIG. 1B, in the present embodiment, each of the touch sensing electrodes 120 is a strip electrode pattern crossing over the scan lines 142, and a space 122 between two adjacent touch sensing electrodes 120 is located right above the data line 144. A material of the touch sensing electrodes 120 is indium tin oxide (ITO), indium antimony oxide or indium zinc oxide (IZO), etc. The cover plate 110 is a cover lens, and a user can view images from a side of the touch display panel 100 where the cover plate 110 is located.

In the present embodiment, the touch sensing electrodes 120 are disposed on the cover plate 110, and gate lines in the display panel 130 are directly used as the scan lines 142. Namely, besides the components required for displaying, only a electrode layer is additionally configured on the cover plate 110 of the touch display panel 100 to form the touch sensing electrodes 120, so as to achieve both of the touch function and the display function. Therefore, the touch display panel 100 may achieve a design requirement of thinness, and the touch display panel 100 may also have a simple fabrication process and a simple structure. Moreover, since the scan signals of the gate lines directly serve as the scan signals for touch sensing, the touch display panel 100 can accurately position a touch point for changing a display image. In addition, since the touch sensing electrodes 120 are disposed on the cover plate 110, the touch sensing electrodes 120 are less influenced by other wires in the display panel 130, and a certain distance is maintained between the touch sensing electrodes 120 and the scan lines 142, so that the touch display panel 100 may have a better sensitivity.

### Second Embodiment

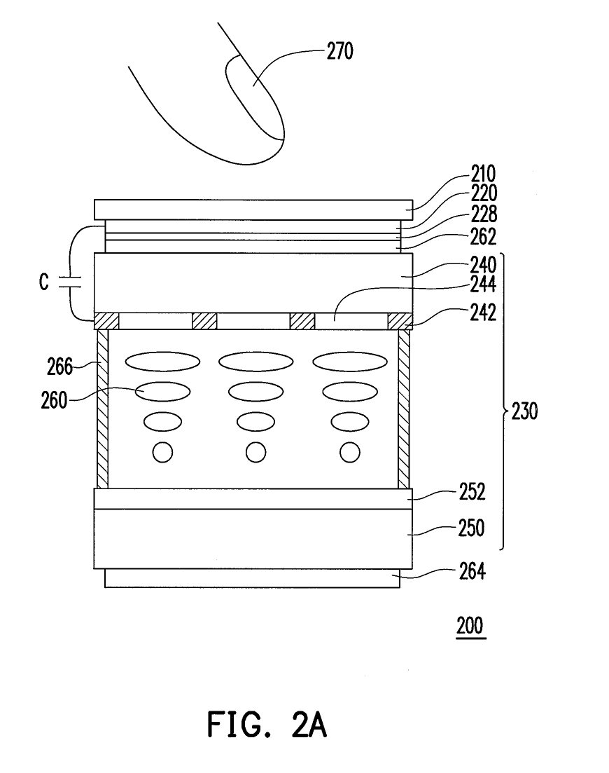

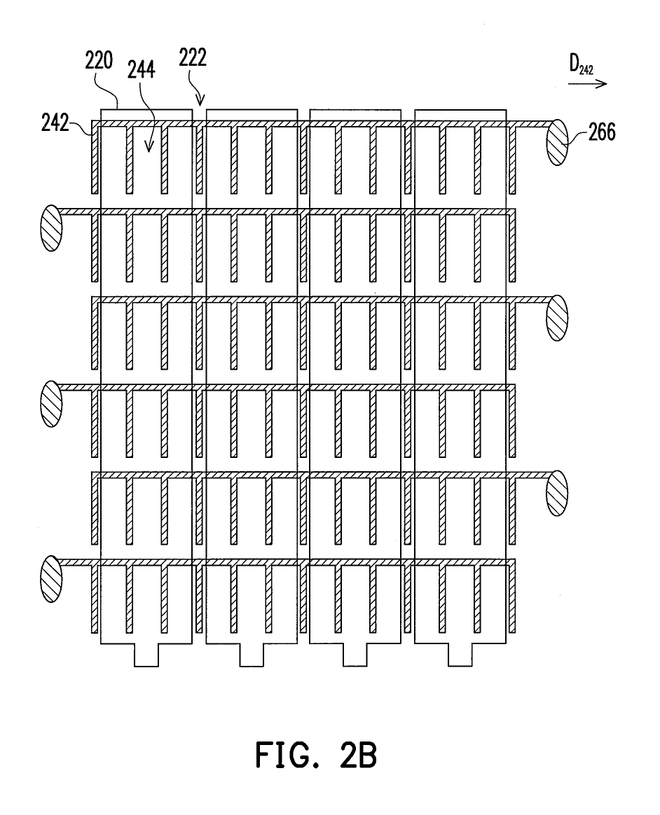

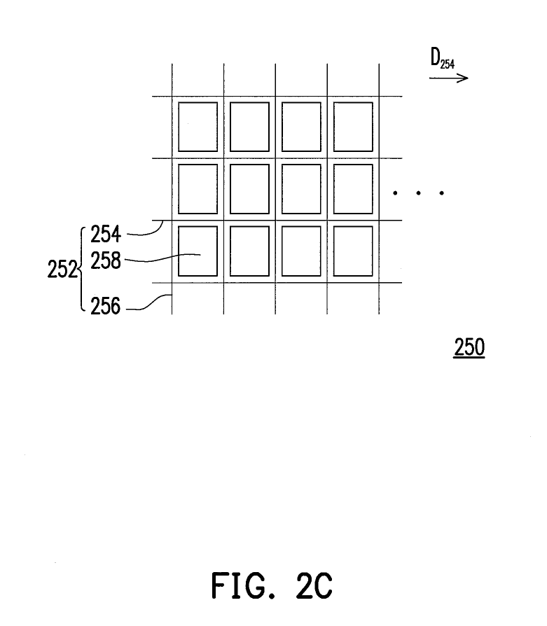

Referring to FIG. 2A and FIG. 2B, the touch display panel 200 includes a cover plate 210, a plurality of touch sensing electrodes 220, an adhesion layer 228 and a display panel 230.

The display panel 230 includes a substrate 240, a plurality of scan lines 242, an opposite substrate 250 and a display medium layer 260, wherein the opposite substrate 250 is parallel to the substrate 240. The touch sensing electrodes 220 are disposed between the cover plate 210 and the substrate 240. The scan lines 242 are disposed on the substrate 240, and the display medium layer 260 is disposed between the substrate 240 and the opposite substrate 250. A sensing capacitance C is formed between the touch sensing electrodes 220 and the scan lines 242, and when a conductive object 270 approaches the cover plate 210, a position of the conductive object 270 can be calculated according to a variation of the sensing capacitance C.

Referring to FIG. 2B and FIG. 2C, in the present embodiment, the scan lines 242 are a plurality of light-shielding patterns separated from each other, and the scan lines 242 form a mesh light-shielding structure.

In the present embodiment, the touch display panel 200 includes a plurality of color filter patterns 244 disposed in the mesh light-shielding structure formed by the scan lines 242. The scan line 242 has a comb-shape, and a material thereof includes chromium, chromium oxide or resin. The substrate 240 is transparent substrate such as a glass substrate, and the cover plate 210 is a cover lens.

The touch display panel 200 includes a pixel array 252 disposed on the opposite substrate 250. The pixel array 252 includes a plurality of gate lines 254, a plurality of data lines 256 and a plurality of pixel structures 258. Each of the pixel structures 258 is electrically connected to one of the gate lines 254 and one of the data lines 256, and the data lines 256 are not parallel to the gate lines 254. An extending direction D₂₅₄ of the gate lines 254 is parallel to an extending direction D₂₄₂ of the scan lines 242.

The touch display panel 200 further includes a conductive element 266, and each scan line 242 is connected to one of the gate lines 254 of the pixel array 252 through the conductive element 266. The conductive element 266 is a conductive spacer, which is disposed between the substrate 240 and the opposite substrate 250 for connecting the scan lines 242 and the gate lines 254. Therefore, during the operation of the pixel array 252, the gate lines 254 gradually scan so that signals in the data lines 256 are transmitted to the corresponding pixel structures 258. Now, scan signals of the scan lines 254 are transmitted to the scan lines 242 through the conductive element 266 to serve as scan signals for touch sensing. Therefore, it is unnecessary to configure additional touch scan devices to the touch display panel 200 of the present embodiment for the touch function. Moreover, in an embodiment that is not shown, each of the scan lines 242 can also be connected to one of the data lines 256 of the pixel array 252 through the conductive element 266, and the signal of the data line 256 is transmitted to the scan line 242 through the conductive element 266 to serve as the scan signal for touch sensing.

In the present embodiment, each of the touch sensing electrodes 120 is a strip electrode pattern crossing over the scan lines 242. Moreover, a space 222 between two adjacent touch sensing electrodes 220 is located right above the data line 256.

The touch sensing electrodes 220 are disposed on the cover plate 210, and the light-shielding patterns in the display panel 230 are directly used as the scan lines 242, so that touch devices can be omitted, and the touch display panel 200 may have a thinner thickness.

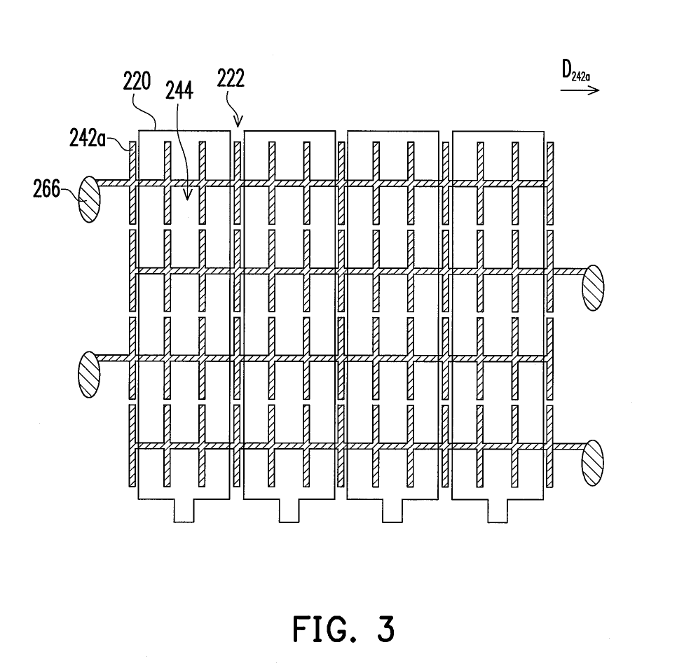

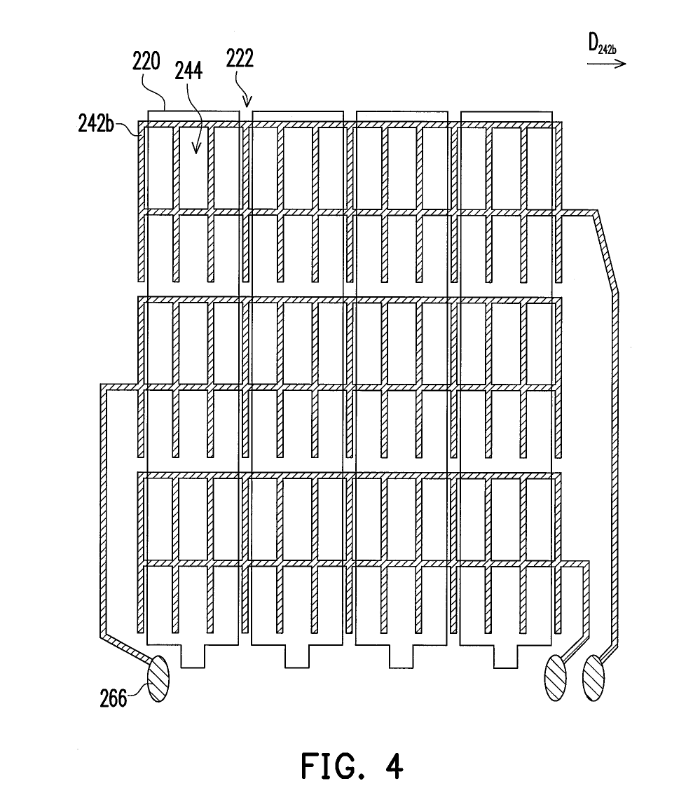

Besides the comb-shape scan lines 242, the scan lines 242 serving as the light-shielding patterns may have another shape as that shown in FIG. 3. In FIG. 3, each of scan lines 242a may have a fishbone-shape, and an extending direction thereof is D₂₄₂ₐ. Alternatively, as that shown in FIG. 4, an extending direction of scan lines 242b is D_{242b}.

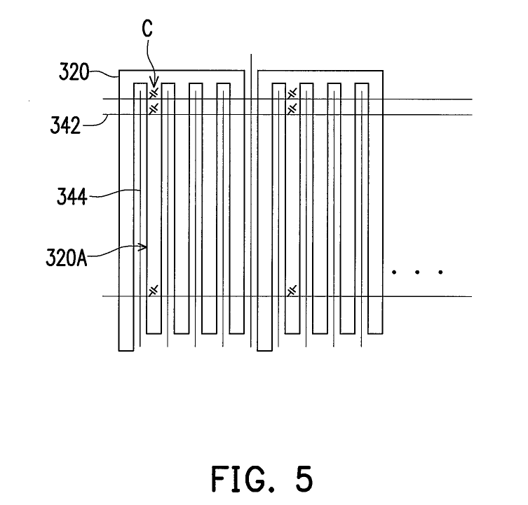

FIG. 5 is a top view of touch sensing electrodes of a touch display panel according to an embodiment of the invention, in which only the touch sensing electrodes 320, scan lines 342 and data lines 344 are illustrated. In the present embodiment, each of the touch sensing electrodes 320 crosses over a plurality of the data lines 344. To reduce interference of the touch signals caused by the data lines 344 in a pixel array (not shown), each of the touch sensing electrodes 320 has a plurality of openings 320A, and each of the openings 320A exposes one of the data lines 344. Such design avails improving sensitivity of the touch sensing operation.

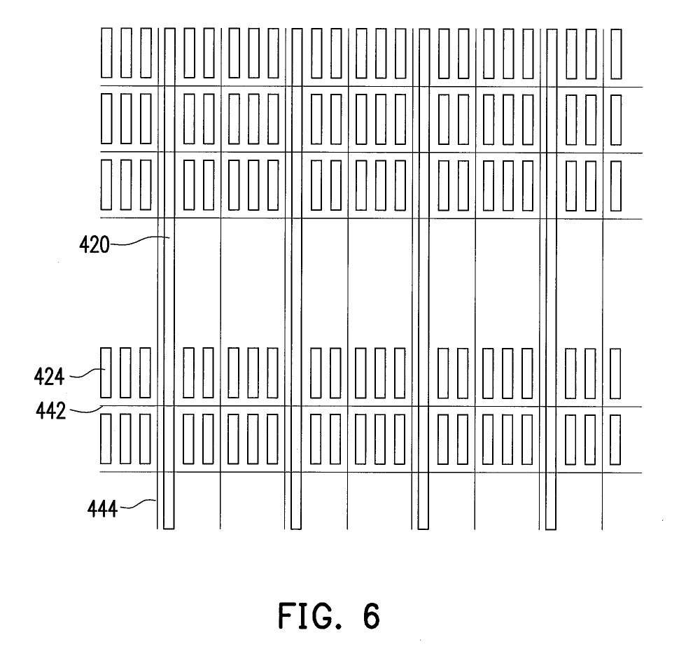

Referring to FIG. 6, the touch sensing electrodes 420 are electrode patterns with narrow line width. Moreover, in FIG. 6, the touch sensing electrodes 420 and data lines 444 are not overlapped. In this way, signals transmitted by the data lines 444 are not liable to influence touch control signals. In addition, the present implementation further includes a plurality of dummy electrodes 424. The dummy electrodes 424 and the touch sensing electrodes 420 are in a same film layer, and the dummy electrodes 424 are disposed between two adjacent touch sensing electrodes 420. The dummy electrodes 424 avails reducing mutual interference of signals in the touch sensing electrodes 420. Therefore, the dummy electrodes 424 avails improving accuracy of the touch sensing operation.

In summary, in the invention, the touch sensing electrodes are disposed on the cover plate, and devices in the display panel can directly serve as the scan lines for touch sensing. Therefore, in the touch display panel of the invention, besides the devices required by the display panel, only one layer of touch sensing electrodes is required to be disposed on the cover plate, and then the cover plate is adhered to the display panel to complete the fabrication of the touch display panel. Therefore, a fabrication process of the touch display panel can be greatly simplified, and the touch display panel may satisfy a design requirement of thinness. In addition, since the touch sensing electrodes are disposed on the cover plate, the touch sensing electrodes are less influenced by other wires in the display panel, and a certain distance is maintained between the touch sensing electrodes and the scan lines, so that the touch display panel may have a better sensitivity. Moreover, a special pattern design such as openings can be used or dummy electrodes can be configured to further improve the sensitivity of the touch sensing electrodes.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch display panel, comprising:
a cover plate;
a plurality of touch sensing electrodes, disposed on a surface of the cover plate; and
a display panel, adhered to the cover plate via an adhesion layer, and comprising:
a substrate, wherein the touch sensing electrodes are disposed between the cover plate and the substrate;
a plurality of scan lines, disposed on a side of the substrate, the scan lines and the touch sensing electrodes disposed at different sides of the substrate, and a sensing capacitance being formed between the touch sensing electrodes and the scan lines;
an opposite substrate, parallel to the substrate; and
a display medium layer, disposed between the substrate and the opposite substrate.

2. The touch display panel as claimed in claim 1, wherein the scan lines comprise a plurality of gate lines.

3. The touch display panel as claimed in claim 2, wherein the display panel further comprises a plurality of data lines and a plurality of pixel structures disposed on the substrate, each of the pixel structures is connected to one of the gate lines and one of the data lines, and a space between two adjacent touch sensing electrodes corresponds to one of the data lines.

4. The touch display panel as claimed in claim 3, wherein each of the touch sensing electrodes has at least one strip opening, and the strip opening corresponds to one of the data lines.

5. The touch display panel as claimed in claim 1, wherein the scan lines comprise a plurality of light-shielding patterns separated from each other, and the light-shielding patterns form a mesh light-shielding structure.

6. The touch display panel as claimed in claim 5, wherein the display panel further comprises a plurality of color filter patterns disposed in the mesh light-shielding structure.

7. The touch display panel as claimed in claim 5, wherein a shape of each of the light-shielding patterns comprises a comb-shape or a fishbone-shape.

8. The touch display panel as claimed in claim 5, wherein a material of the light-shielding patterns comprises chromium, chromium oxide or resin.

9. The touch display panel as claimed in claim 5, further comprising a pixel array disposed on the opposite substrate, the pixel array comprising a plurality of gate lines, and an extending direction of the gate lines being parallel to an extending direction of the scan lines.

10. The touch display panel as claimed in claim 9, wherein each of the scan lines is connected to one of the gate lines in the pixel array through a conductive element.

11. The touch display panel as claimed in claim 10, wherein the conductive element comprises a conductive spacer disposed between the substrate and the opposite substrate.

12. The touch display panel as claimed in claim 1, wherein each of the touch sensing electrodes crosses over the scan lines.

13. The touch display panel as claimed in claim 1, further comprising a plurality of dummy electrodes, located at a same film layer with that of the touch sensing electrodes, and disposed between two adjacent touch sensing electrodes.

14. The touch display panel as claimed in claim 1, further comprising a polarizer disposed on an outer surface of the substrate, and disposed between the substrate and the adhesion layer.

15. The touch display panel as claimed in claim 1, further comprising a polarizer disposed on an outer surface of the opposite substrate, wherein the opposite substrate is located between the display medium layer and the polarizer.

16. The touch display panel as claimed in claim 1, wherein a material of the touch sensing electrodes comprises indium tin oxide, indium antimony oxide or indium zinc oxide.

17. The touch display panel as claimed in claim 1, wherein a material of the display medium layer comprises a liquid crystal material, a plasma material, an organic light emitting display material or an electrophoresis material.

18. The touch display panel as claimed in claim 1, wherein the cover plate is a cover lens.
